(19) United States
(12) Patent Application Publication
(10) Pub. No.: US 2012/0213986 A1
(43) Pub. Date: Aug. 23, 2012

(54) PROCEDURES FOR DEVELOPMENT OF SPECIFIC CAPACITANCE IN CARBON STRUCTURES

(75) Inventors: Tomasz Kowalewski, Pittsburgh, PA (US); Eun Kyung Kim, Pittsburgh, PA (US); John P. McGann, Pittsburgh, PA (US); Krzysztof Matyjaszewski, Pittsburgh, PA (US)

(73) Assignee: CARNEGIE MELLON UNIVERSITY, Pittsburgh, PA (US)

(21) Appl. No.: 13/390,470

(22) PCT Filed: Aug. 17, 2010
(86) PCT No.: PCT/US10/02257

§ 371 Date: Apr. 10, 2012

Related U.S. Application Data
(60) Provisional application No. 61/274,401, filed on Aug. 17, 2009.

(51) Int. Cl. B32B 3/26; C01B 31/00

(52) U.S. Cl. 428/304.4; 264/29.1

(57) ABSTRACT

The present disclosure describes a carbon electrode having a high specific capacitance and method for forming an electrode. The electrode includes a graphitic carbon material having porous nanographene structures with edge-on topology to a plurality of formed pores, dispersed in an amorphous carbon matrix. The graphitic carbon material is formed by pyrolysis of phase separated block copolymers.

This research was partially supported by the National Science Foundation under Award No. DMR-0304508.

### FIELD OF THE INVENTION

The present invention relates to the preparation of carbon based materials wherein the formed graphitic carbon structures or nanographene sheets present an edge-on configuration to the environment thereby providing carbons suitable for use as improved anode materials for lithium ion batteries and supercapacitor electrodes displaying high specific capacitance per unit area.

### BACKGROUND OF THE INVENTION

Patent application WO 02/081372, (International Application No.: PCT/US2002/010811) which is hereby incorporated by reference, discloses a process for the preparation of nanostructures carbon based materials and discusses potential uses of the macroscopically organized materials. We have now discovered that if the precursor for the nanostructured carbon is synthesized or fabricated in such a manner that the molecular segments in the carbon precursor phase assume a molecularly constrained orientation to the phase boundary, the nature of the carbon phase formed after the stabilization and carbonization process displays charge carrier properties indicative of the presence of an edge on graphene sheet.

There are various forms of sp²-bonded carbon with a range of degrees of graphitic ordering. As such, carbon materials can have a mixture of sp², sp³, and sp¹ sites. The sp² and sp³ sites possess a bonds with filled a and unfilled a* states, separated by a gap of 4-6 eV. The π-π* states lie much closer to the Fermi level and are entirely within the σ-σ* energy gap. As a result, the ratio of sp² to sp³ sites often helps determine the optical and electrical properties of carbon materials. The metallic nature of graphite results from sp² hybridization of carbon, where π and π* orbitals in an ‘infinite’ graphite sheet overlap at the edges of the first Brillouin zone. [H. O. Pierson, Handbook of Carbon, Graphite, Diamond and Fullerenes (Noyes Pub. Park Ridge N.J., 1993)] However, in nanostructured carbon films, which contain both nanometer-sized graphitic (sp²) clusters and amorphous (sp³) carbon domains, this is not the case. The quantum confinement of charge carriers causes a decreasing band gap with increasing cluster size, meaning the optical and electrical properties are similarly controlled. [K. B. K. Teo, S. E. Rodil, J. T. H. Tsai, A. C. Ferrari, J. Robertson, and W. Milne, J. Appl. Phys. 89, 3706 (2001)] Thus, if it were possible to engineer the size of graphitic domains, it may be possible to achieve control over the electrical properties of nanostructured materials.

A graphene sheet can be considered as a 2-D polymer of sp² carbon which serves as a building material for carbon graphitic sheets of all dimensionalities, Scheme I, which also illustrates the different edge topology that can be presented by a nano-graphene sheet.

Energy devices adopting electrochemical energy conversion, such as secondary batteries, particularly lithium ion batteries, fuel cells or supercapacitors (also called electrochemical capacitors), have attracted a lot of interest due to their more sustainable and more environmental-friendly aspects of the synthesis and fabrication processes. Contrary to batteries and fuel cells, in supercapacitors electrical charge is stored in the electrical double layer (EDL), which forms at the electrode/electrolyte interface mainly by electrostatic attraction. [Conway, B. E. Electrochemical Supercapacitors: Scientific Fundamentals and Technological Applications; Springer, 1999.] The maximal charge density is accumulated at the distance of the outer Helmholtz plane, i.e. at the center of the electrostatically attracted solvated ions.

Supercapacitors have an unusually high energy density compared with conventional capacitors due to their highly porous electrodes. Certain carbon materials have been used in electrodes in supercapacitors due to their low cost, easy processability, accessibility, relatively high electrical conductivity and good electrochemical stability. [Frackowiak, E. Carbon materials for supercapacitor application, Phys Chem Chem Phys, 2007, 9, 1774-1785.] For the EDL to be charged efficiently, the electrode material should have a high surface area and the pore sizes corresponding to the size of the ions. Thus, activated carbons are typically used as electrode material for supercapacitors because the pore size can be more or less controlled depending on the type of precursor and activation method (physical or chemical).

One approach to improve the properties of carbon based supercapacitor materials includes improving the rate capabilities and the overall capacitance. Herein are disclosed procedures that generate graphitic carbon materials suitable for preparation of supercapacitor electrodes displaying high specific capacitance per unit area.

There are two general mechanisms for energy storage in supercapacitors. The most common mechanism is through the electrical double layer (EDL), which forms at the electrode/electrolyte interface mainly by electrostatic attraction. This mechanism is purely electrostatic as charges are not transferred to the electrode, but rather stored on the surface.

Alternatively, redox processes or pseudocapacitance on the surfaces of materials may contribute to the overall capacitance. Ruthenium oxide and manganese oxide are the most commonly studied materials which exhibit significant pseudocapacitance effects. [Chang, K.-H.; Wu, Y.-T.; Hu, C.-C. In “Recent Advances in Supercapacitors” Gupta, V., Ed.; Old City Publishing, Inc., 2005, pp 29-56 and Belanger, D.; Brousse, T.; Long, J. W. “Manganese oxides: battery materials make the leap to electrochemical capacitors” Electrochem. Soc. Int., 2008, 17, 49-52.] However, these materials are far from being viable at an industrial scale since they require highly complicated procedures for fabrication of the electrodes and are prone to mechanical degradation.

Functional groups such as ketones, pyridines, etc. containing oxygen or nitrogen on the surface of carbon materials used as electrodes may enhance the capacitance through additional pseudocapacitance effects. Therefore, some researchers have utilized this approach to pseudocapacitance enhancement through the use of carbon precursors in the form of polymers already rich in nitrogen such as polyacrylonitrile (PAN) or oxidized poly(4-vinylpyridine) cross-linked with 25 wt % of divinylbenzene and their blends with pitch, followed by steam—activation to provide activated carbon structures. [Frackowiak, E, et.al; Electrochimica Acta 2006, 51, 2209-2214 and Chem Phys Lett, 2005, 404, 53-58.]

A summary of the state of the art is provided in Table 1 and in FIG. 1, which show that typical values of EDL specific capacitance per unit area of carbon materials are in the range of 5-25 μF/cm². The value for amorphous carbon is in the middle of this range.

TABLE I
Major carbon based materials for supercapacitors and their characteristics.

| | | Double-layer | |
|---|---|---|---|
| Carbonaceous | | capacitance | |
| material | Electrolyte | (μF cm⁻²) | Surface Area (m²g⁻¹) |
| Activated Carbon | 10% NaCl | 19 ^{a} | 1200 |
| Carbon Black | 1M H₂SO₄ | 8 ^{b} | 230-1200 |
| | 31 wt. % KOH | 10 ^{c} | |
| Carbon Fiber Cloth | 0.51M Et₄NBF₄ | 6.9 ^{d} | 1630 |
| | in propylene | | |
| | carbonate | | |
| Graphite: Basal Plane | 0.9N NaF | 3 ^{e} | Highly Oriented |
| Edge Plane | | 50-70 ^{e} | Pyrolytic Graphite |
| Graphite Powder | 10% NaCl | 35 ^{a} | 4 |
| Graphite Cloth | 0.168N NaCl | 10.7 ^{f} | Solid area 630 m²g⁻¹ |
| Glassy Carbon | 0.9N NaF | −13 ^{g} | Solid |
| Carbon Aerogel | 4M KOH | 23 ^{h} | 650 |

References a to h are:
^{a} Evans, S. J Electrochem Soc 1966, 113, 165;
^{b} Kinoshita, K.; Bett, J. A. S. Carbon 1973, 11, 403-411;
^{c} Gagnon, E. G. J Electrochem Soc 1975, 122, 521-525;
^{d} Tanahashi, I.; Yoshida, A.; Nishino, A. J Electrochem Soc 1990, 137, 3052-3056;
^{e} Randin, J. P.; Yeager, E. J Electrochem Soc 1971, 118, 711-714;
^{f} Soffer, A. J Electroanal Chem 1972, 38, 25;
^{g} Randin, J. P.; Yeager, E. J Electroanal Chem 1972, 36, 257;
^{h} Kinoshita, K. Carbon: Electrochemical and Physicochemical Properties; Wiley: New York, 1988.

One largely unexplored area in existing art is related to specific capacitance per unit area. This is addresses herein. The capacitance for highly oriented pyrolytic edge plane graphite described herein ranges from about 50 to about 70 μF/cm², which is far superior to all other known carbon storage mechanisms. As will be described herein, nanostructured carbon (ns-C) films can be prepared under conditions that provide a highly porous structure, thereby making them promising candidates for electrodes for supercapacitors, batteries, and fuel cells.

### DESCRIPTION OF EMBODIMENTS OF THE INVENTION

The present disclosure provides for the use of novel porous carbon materials having nanographene sheets as electrodes in electronic applications.

According to one embodiment, the present disclosure provides an electrode comprising a porous carbon material comprising a graphitic carbon material containing nanographene structures with edge-on topology to a plurality of formed pores, dispersed in an amorphous carbon matrix. The electrode has a specific capacitance per unit area of greater than about 30 μF/cm². The electrodes may be used in electronic applications such as an electrode in a supercapacitor or an electrode in a lithium ion battery.

In another embodiment, the present disclosure provides a method for forming an electrode. The method comprises forming a phase separated block copolymer having a carbon precursor phase and a sacrificial phase; chemically or thermally removing the sacrificial phase and pyrolizing the block copolymer to convert the carbon precursor phase into a porous carbon material comprising a graphitic carbon material having a nanoporous structure containing nanographene structures with edge-on topology to a plurality of formed pores; grinding the porous carbon material into a graphitic powder having a particle size ranging from about 1 nm to about 100 nm; and forming an electrode from the graphitic powder.

### DESCRIPTION OF THE FIGURES

FIG. 1: Characteristics of various carbons as supercapacitor electrodes. (Data adapted from Table 1 of a recent review Carbon based materials as supercapacitor electrodes by L. L.Zhang and X. S. Zhao. Chem.Soc.Rev., 2009, DOI : 10.1039/b813846j, first published on the web Jun. 12, 2009.)

FIG. 2. Schematic representation a procedure used to form ordered carbon structures further comprising π-π stacking in lamellae morphologies as seen by GIWAXS.

FIG. 3.(a) Nitrogen isotherm; and (b) pore size distribution for nanocarbon prior to (NC) and post CO₂ activation (AC).

FIG. 4.(a) WAXS, (b) Raman, and (c) Laser desorption ionization Time-Of-Flight Mass Spectrometry of carbon prepared from PAN-b-PBA

FIG. 5.(a), (b), and (c) are Galvanostatic charge-discharge curves; and (d) cyclic voltammetry results for nanocarbon supercapacitor sample derived from a PAN-b-PBA precursor.

FIG. 6.(a) SARA of a carbon powder sample and (b) a baseline subtracted azithumally averaged scattering profile.

FIG. 7. Plot of specific capacitance values for nanocarbon samples from PAN-b-PBA precursors with varying wt. % of PAN.

FIG. 8. Transition electron microscope (TEM) image of a carbon prepared from a (AN)₁₁₄-b-(BA)₇₈ copolymer. 37.7% PAN in the copolymer.

FIG. 9. Carbon nanofoam films from “hairy” polyacrylonitrile-grafted colloidal silica nanoparticles.

### DETAILED DESCRIPTION

Other than the operating examples, or where otherwise indicated, all numbers expressing quantities of ingredients, processing conditions and the like used in the specification and claims are to be understood as being modified in all instances by the term “about”. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical values, however, may contain certain errors, such as, for example, equipment and/or operator error, necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of less than or equal to 10.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure describes several different features and aspects of the invention with reference to various exemplary non-limiting embodiments. It is understood, however, that the invention embraces numerous alternative embodiments, which may be accomplished by combining any of the different features, aspects, and embodiments described herein in any combination that one of ordinary skill in the art would find useful.

High performance electrochemical capacitors (i.e., supercapacitors) represent one of the major energy storage solutions as they generally store significantly more energy (˜5 Wh/g) than conventional capacitors and offer much higher power delivery or uptake (10 kW/kg) than lithium ion batteries. Supercapacitors may be classified into two types according to their charge-storage mechanism: a) the electric double-layered capacitor (EDLC) in which the electrical charge is accumulated in the double layer mainly by electrostatic forces across the electrode/electrolyte interface; and b) the Faradaic pseudocapacitor in which electric charge is stored by rapid redox reactions at the electrode surfaces. Porous carbon materials described herein are considered excellent candidates for high performance supercapacitors due, at least in part, to their high surface area and chemical stability.

Recently controlled/living radical polymerization processes (CRP) have been developed. Atom Transfer Radical Polymerization (ATRP), nitroxide mediated polymerization (NMP), reversible addition fragmentation chain transfer (RAFT) and catalytic chain transfer (CCT) are examples of CRP processes that provide a relatively new and versatile methods for the synthesis of polymers with controlled molecular weight, low polydispersity and site specific functionality from a broader range of monomers than “living” ionic polymerization processes. Indeed, since CRP processes provide compositionally homogeneous well-defined polymers and polymeric hybrid materials (with predicted molecular weight, narrow molecular weight distribution, and high degree of a- and co-end-functionalization in each polymer segment) they have been the subject of much study as reported in several review articles. [Matyjaszewski, K., Ed. Controlled Radical Polymerization; ACS: Washington, D. C., 1998; ACS Symposium Series 685. Matyjaszewski, K., Ed. Controlled/Living Radical Polymerization. Progress in ATRP, NMP, and RAFT; ACS: Washington, D. C., 2000; ACS Symposium Series 768. Matyjaszewski, K., Davis, T. P., Eds. Handbook of Radical Polymerization; Wiley: Hoboken, 2002. Qiu, J.; Charleux, B.; Matyjaszewski, K. Prog. Polym. Sci. 2001, 26, 2083. Davis, K. A.; Matyjaszewski, K. Adv. Polym. Sci. 2002, 159, 11 The formed materials can be fabricated under controlled conditions forming physically well defined solids. Such polymerization methods may be particularly suited for synthesizing polymers useful for the structures described herein.

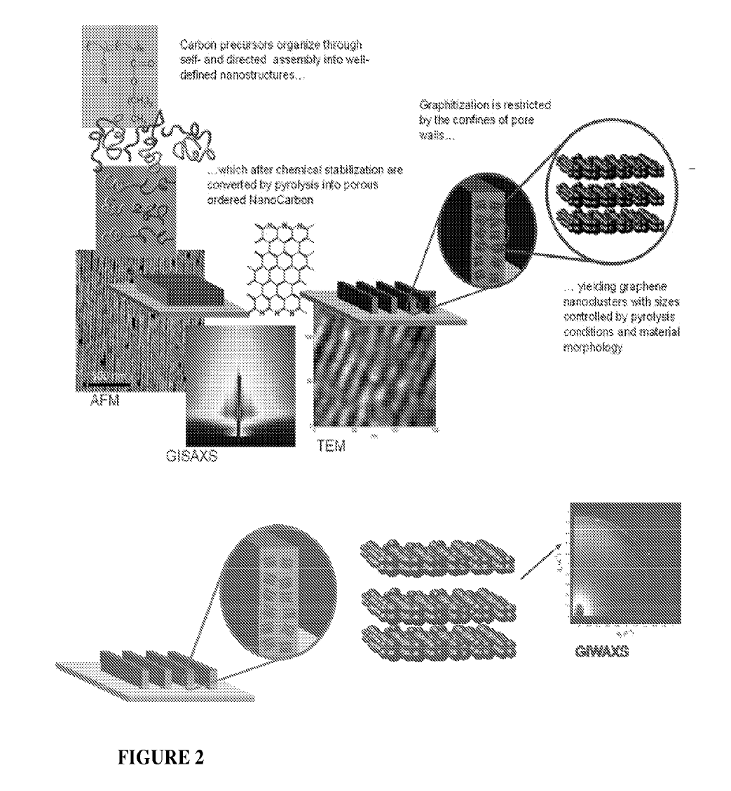

For example, CRP methodologies may be suited for forming bi-phasic materials comprising a carbon precursor phase wherein the phase separated morphology is preferentially spherically morphology, cylindrical morphology, gyroidal morphology, lamellar morphology, branched morphology, a continuous carbon phase morphology, and combinations of these morphologies can be formed by controlling the composition and fabrication procedure used to form a phase separable segmented copolymer or hybrid material wherein the segmented material phases separate into the desired morphology. In one non-limiting exemplary fabrication procedure, a multiphase macromolecular segmented copolymer comprising a carbon precursor phase is used to form the initial long range ordered lamellae structure in a thin film shown in FIG. 2, by a procedure known as zone casting. After stabilization and pyrolysis, this ordered polymeric structure can be converted into ordered carbon structures. [Kowalewski, T. et. al; Journal of the American Chemical Society 2005, 127, 6918-6919]

In one particular non-limiting exemplary embodiment, a block copolymer containing a carbon precursor phase (such as polyacrylonitrile (PAN)) and a sacrificial block (in one exemplary case, poly(n-butyl acrylate) (PBA)) phase separates at the nanoscale with a morphology determined by the weight ratio of the two blocks. The size of each phase separated domain may be controlled, for example, by the molecular weight of each segment in the phase separated block copolymer. Conversion of the phase separated segmented copolymer to a highly porous nanocarbon material is achieved through a two step heat treatment process, Scheme II and FIG. 2. The first step is performed at lower temperature in air to crosslink and partially cyclize the PAN phase, see left hand side of Scheme II. This step preserves the nanostructure upon further heat treatment. The second step comprising further cyclization followed by dehydrogenation, denitrogenation and conversion to graphitic structures, is conducted upon continued heating to higher temperatures under an inert atmosphere. Typically heat treatment of at least above 600° C. in N₂ gas results in this non-limiting exemplary example in the formation of nano-graphene sheets of sizes approximately 2-8 nm, for even 3-5 nm, in both directions in an amorphous carbon matrix.

When a block copolymer is the precursor, the resultant nanocarbon material takes on the morphology of the first phase separated precursor segmented copolymer and in one embodiment, the nanocarbon domains tend to be ˜10 nm in width with pore sizes ˜10-30 nm.

FIG. 2 illustrates the steps required to form one embodiment of the materials herein and highlights the formation of π-π stacking of the formed carbon lamella. In this schematic, a film of a well defined phase separated block copolymer is formed through zone casting and converted to lamellar carbon structures by controlled stabilization of the PAN phase followed by pyrolysis. The orientation of the PAN molecules in the first phase separated material results in formation of graphene nano-sheets with edge on topology to the formed pores, as demonstrated by Grazing Incidence Wide Angle X-ray Scattering (GIWAXS).

Four general routes for the production of the desired carbon structures from polymeric precursors have been developed which through heat treatment are converted into nano-carbon materials exhibiting the desired edge-on configuration of graphitic nano-structures. These routes include synthesis of block copolymers, polymer grafting from a surface, polymer grafting from a porous template, and polymer grafting from silica nanoparticles. As recited above, CRP methodologies may be suited for the polymerization processes necessary in these routes.

Powders of carbon materials prepared by these methods exhibit high surface areas, some as high as 500 m²/g or more. This increased surface area is due to the presence of nanoporous structure in these materials, correlating roughly to the volume of the sacrificial material.

Control over the composition of each carbon precursor material in each of the synthetic methods mentioned herein provides the conditions to create a fraction of graphene structures with the desired edge-on orientation to the pores after fabrication and controlled pyrolysis. In one embodiment, greater than 50% of the graphene structures may have the edge-one orientation.

As discussed in detail herein, without intending to be limited by any mechanism, it is proposed that in the case of block copolymer precursors this is a consequence of polymer chain stretching at the interface between immiscible phases; whereas in the case of surface grafted materials this edge on orientation can result from high graft density and consequential close packing of the tethered chains, Scheme III.

The porosity of the final carbon structure can be modified, for example, by using block copolymers having different mole fractions of the carbon precursor and the sacrificial phase, and/or different molecular weights of the carbon precursor phase and the sacrificial phase, preparation of copolymers of differing controlled topology, or by the use of materials with other sacrificial phases such as silica particles of porous silica substrates whose synthesis was disclosed by one of the present inventors in a number of publications to exemplify the scope of materials that can be prepared by CRP. (International Application No.: PCT/US2002/010811). [Kowalewski, et.al; J Am Chem Soc, 2002, 124, 10632-10633; Angewandte Chemie, International Edition, 2004, 43, 2783-2787; J Am Chem Soc, 2005, 127, 6918-6919; J Phys Chem B, 2005, 109, 9216-9225; Chem Mater, 2006, 18, 1417-1424; Macromolecules, 2007, 40, 6199-6205; J Am Chem Soc, 2007, 129, 8694-8695; Advanced Materials, 2008, 20, 1516-1522; Synthetic Met, 2009, 159, 177-181.] Porosity may optionally be enhanced by physically forming micropores in the block copolymer prior to stabilization and pyrolysis. In one embodiment, a high fraction of carbon precursor polymer segments may be oriented perpendicularly to an interface. Suitable interfaces include a phase separated segmented copolymer (such as a block of the sacrificial phase polymer) or a hybrid material (such as an inorganic substrate, for example a silica (SiO₂) substrate). In one embodiment, greater than 50% of the carbon precursor polymer segments are oriented perpendicularly to the interface. In other embodiments greater than 70% of the carbon precursor polymer segments are oriented perpendicularly to the interface.

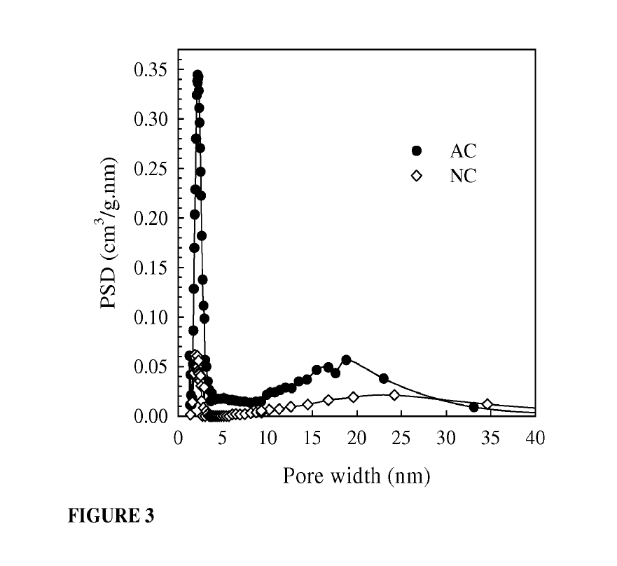

The porous carbon materials synthesized by this process may be ground or otherwise pulverized to form a particulate material or powder. Specific embodiments of the porous carbon material may be a powder having a particle size ranging from about 1 μm to about 100 μm. Typical BET surfaces areas of an exemplary material, formed by the process illustrated in Scheme II and FIG. 2, is greater than 300 m²/g, for example, from about 300 m²/g to about 800 m²/g. In specific embodiments, the surface area of the particles may be ˜500 m²/g, although CO₂ activation has been shown to increase the surface area to greater than 1100 m²/g, see FIG. 3.

When the mole fraction of the carbon precursor phase is appropriately selected, each of these approaches result in preparation of a carbon material with similar structure, one comprising a porous carbon phase with pores of different dimensions, each with different advantages and disadvantages for specific targeted applications. This prior art work focused on the ability to control the conductivity of the macroscopically ordered, formed carbon nanostructured films and to easily form ohmic contacts in the as-deposited state. As disclosed herein, the present disclosure overcomes the limitations of the need to prepare well defined films of the carbon nanostructured precursor and to stabilize/pyrolize the first formed films.

In one non-limiting exemplary application, lithium-ion batteries are presently in high demand especially in the automotive field for hybrid vehicles. Improving the electrode materials is one of the most pressing issues in order to create higher rate capability (i.e. faster charging/discharging) and higher capacity batteries. To date, graphite is the most commonly used anode material for storage of lithium ions because of its low cost, low electrochemical potential with respect to lithium metal than most metal oxides, chalcogenides and polymers, [Winter, M.; Besenhard, J. O.; Spahr, M. E.; Novak, P. Advanced Materials 1998, 10, 725-763; Dahn, J. R.; Zheng, T.; Liu, Y. H.; Xue, J. S. Science 1995, 270, 590-593.] and its dimensional stability upon intercalation compared to lithium alloys. There are several limitations of graphite as the anode material that have been thoroughly investigated in the past decade or so. First is the low theoretical storage capacity of 372 Ah/kg, which corresponds to the stoichiometric amount for LiC₆. [Megahed, S.; Scrosati, B. J Power Sources 1994, 51, 79-104.] Second is the low rate capability (primarily due to the slow chemical diffusion of the ions), [Levi, M. D.; Aurbach, D. J Phys Chem B 1997, 101, 4641-4647; Wang, Q.; Li, H.; Huang, X. J.; Chen, L. Q. Journal of the Electrochemical Society 2001, 148, A737-A741.] which limits their utility for higher power devices such as motor vehicles. [Habazaki, H.; Kiriu, M.; Konno, H. Electrochemistry Communications 2006, 8, 1275-1279; Herstedt, A.; Fransson, L.; Edstrom, K. J Power Sources 2003, 124, 191-196.] Work disclosed herein describes an attempt to improve upon both challenges.

Lithium ions stored in graphite electrodes are arranged in the basal plane of π-π stacked molecules, and result in a transition from AB stacking to AA stacking (Scheme IV). Given this, for smaller graphitic molecules, such as the carbon material comprising graphitic carbons having oriented nano-graphene sheets described in detail herein, one would expect that a higher specific charge would require a larger volume of material in order to accommodate the ions.

However, several other models have been proposed in the literature [Advanced Materials 1998, 10, 725-763.] that indicate other mechanisms could be utilized for lithium ion storage in mesoporous carbon materials, as exemplified in Scheme V.

Peled and co-workers [Journal of the Electrochemical Society 1997, 144, 3484-3491.] suggested that additional storage can be a result of some oxidation of the graphite zigzag and armchair edges between adjacent crystallites and near defects and impurities. It has also been proposed, and commonly accepted, that nanometer-sized graphitic molecules can store a substantial amount of lithium ions on the unmodified armchair and zigzag edges (see Scheme I) in addition to the basal plane (Scheme IVc) and that an even larger amount of lithium ions can be handled in the cavities themselves. [Science 1994, 264, 556-558; J Power Sources 1995, 54, 440-443 and 444-447.] To evaluate such effects, the existence of these different lithium ion sites have been studied. [J Power Sources 1995, 56, 205-208; Electrochim Acta 1997, 42, 2537-2543.] We envisioned that developing the ability to fabricate such highly controlled structures will lead to improvements in the energy density of these devices. In addition, much attention has recently been focused on both graphitic and disordered mesoporous carbon materials (between 10 and 50 nm) in order to induce an optimal ion transport pathway. A highly mesoporous material is well suited for such applications, because smaller pores (<2 nm) result in irreversible storage and larger pores decrease the overall capacity of the material.

The nanocarbon material described in this disclosure fits the criteria for an improved anode material in both presented challenges.

The present description discloses approaches to accomplish the objective of establishing the unique electronic properties of nanographenes attributed to the high concentration of electron density along zigzag edges and very high polarizability of edge states; and comprises processes for the preparation of porous carbon structures based on multi-phase macromolecular carbon precursors which assure an increased fraction of the edge-on orientation of nanographitic domains with respect to pore walls, thus facilitating high specific capacitance per unit area. Therefore, in one embodiment of the invention we disclose processes for preparation of porous carbon structures based on pyrolysis of a multi-phase macromolecular precursors where the molecular orientation of polymer chains in the carbon precursor phase assure the formation of edge-on orientation within the formed nanographitic domains with respect to pore walls, thus facilitating formation of electrodes with high specific capacitance per unit area. Such materials can be ground into carbon particles or powders that are suitable for use as components of electrodes in electronic applications, for example, for lithium ion batteries and as supercapacitor electrodes, as high specific capacitance per unit area is a requirement for commercially viable electrodes. The particle size of the ground carbon particles ranges from between about 1 μm to about 100 μm and have a BET surface area greater than about 300 m²/g. The ground carbon particles further comprise pores or surfaces exhibiting an increased fraction of the edge-on orientation of nanographitic domains.

Thus, one embodiments of the present disclosure provides for an electrode comprising a porous carbon material comprising a graphitic carbon material having a nanoporous structure containing nanographene structures or sheets with an edge-on topology to a plurality of formed pores or surfaces, dispersed in an amorphous carbon matrix. According to these embodiments the electrode may have a high specific capacitance per unit area, for example, a specific capacitance per unit area of greater than 30 μF/cm², or ranging from about 30 μF/cm² to about 70 μF/cm², or even from about 30 μF/cm² to about 100 μF/cm².

A feature of all synthetic routes reported here is that controlled synthetic and/or fabrication procedures ensure that a high fraction of the precursor polymer chains, for example, greater than 50% or even greater than 70%, are oriented perpendicularly to the interface, either the interface of a phase separated segmented copolymer or the interface of a hybrid material, such as an inorganic material (for example, a silica material). This interface becomes the pore wall or exposed surface after removal of the organic or inorganic sacrificial phase. One additional advantage of this approach is the possibility of integrating it with conventional device fabrication methods. In a non-limiting example, well-defined carbon nanostructures resulting from solution-casting processes are attractive for electrical application(s) because of tunable electronic properties. In another procedure, a photo-lithographic technique can be employed to selectively deposit initiators for the selected CRP to graft the carbon precursor phase from a selected substrate thereby directly forming carbon structures with conducting properties.

The choice of (co)polymer composition (morphology) and pyrolysis temperature can additionally significantly affect the electrical properties of ns-C films. In certain embodiments, the resulting carbon graphitic material may take on the morphology of the phase separated carbon precursor phase. The phase separated carbon precursor phase may have a morphology selected from a spherical morphology, cylindrical morphology, a gyroidal morphology, a lamellar morphology, a branched morphology, a continuous carbon precursor phase morphology, and combinations thereof. In specific embodiments, the morphology of the carbon precursor phase may be lamellar. In various embodiments, the carbon graphitic material may have a lamellar morphology.

In one embodiment of the invention the stabilization and pyrolysis of bi-phasic polymeric materials comprising a carbon precursor phase, wherein the phase separated morphology is preferentially lamellar, creates the situation that the edges of the nano-graphene sheets reside on the side of the carbon domains and are highly accessible for capacitance processes. This results in formation of materials wherein the capacitance value for a given surface area displays properties dramatically improved over that of presently available materials due to the high polarizability and high electronegativity of the nano-graphene sheet edges. This disclosure provides examples of how porous nanostructured carbon materials can be fabricated in such a manner that the orientation of the nano-graphene sheets are enhanced such that a suitable fraction of the edges of the in situ formed carbon sheets will lie perpendicular to the pore wall or exposed surface. In contrast to procedures requiring isolation and manipulation of exfoliated graphene flakes [US Application 20090061312], this can be viewed as a simple one step process.

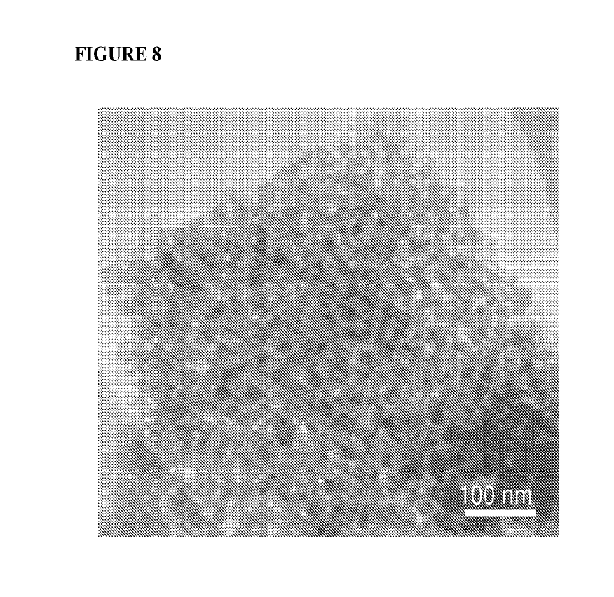

FIG. 2 shows a schematic of one embodiments of a nanocarbon material made from a block copolymer with macroscopically ordered lamellae morphology. [Kowalewski, T. et al.; J Am Chem Soc, 2005, 127, 6918-6919] Surprisingly, as seen by Grazing Incidence Wide Angle X-ray Scattering (GIWAXS), we have determined that the resulting nano-graphene structures within the carbon domains are oriented normal to the carbon domains. As indicated in the schematic, this is a consequence of defining conditions that imposes order in the molecular structure of the polymer segments in the carbon precursor phase. It is known from studies on production of carbon fibers that graphitization tends to proceed along the chain direction. Without intending to be limited by any particular mechanism, it was speculated that the molecular orientation of individual molecules in the carbon phase precursor influences pyrolysis of the precursor polymer and may result in edge plane exposure of the nano-graphene sheet to the surface of the pore. FIG. 8 shows the Transition Electron Microscope (TEM) image of a carbon prepared from by pyrolysis of a (AN)₁₁₄-b-(BA)₇₈ copolymer, 37.7% PAN in the copolymer. The BET specific surface area of the formed carbon structure has a value of ˜300 m² g⁻¹.

The use of a block-brush copolymer with a PAN outer block provides a procedure for the preparation of nanostructured carbons through pyrolysis. [Macromolecules 2007, 40, 6199-6205.] Deposition of a solution of the brush copolymer can provide pre-organization of the first brush block copolymers to form a film on a selected substrate can generate carbon films with ordered linear pores whose dimension is controlled by the MW of the sacrificial phase and whose direction is controlled by the mode of deposition.

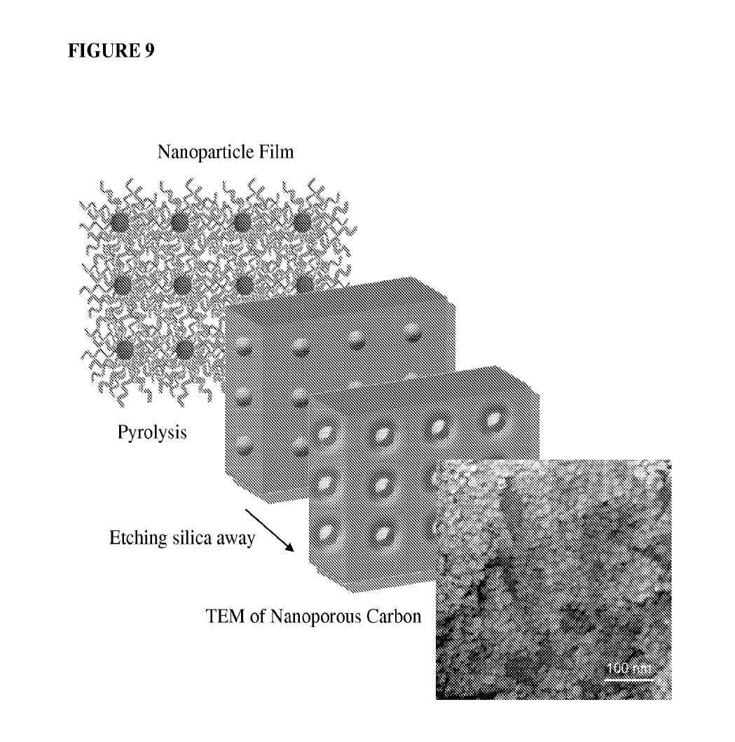

In another embodiment of the invention, dense grafting of the carbon precursor from a solid substrate, either a particle or a flat surface, form a tethered carbon precursor phase that exists in a sterically constrained environment resulting in final carbon domains that comprise graphitic structures as described herein, see Scheme III for a schematic of how densely grafted chains form graphitic structures close to flat surfaces and FIG. 9 for grafted from spherical particles. Dense grafting is defined as grafting density sufficiently high to avoid formation of “mushroom conformation” in the grafted (co)polymer. [Goodman, D.; et. al; Langmuir 2004, 20, 6238-6245.] This is achieved due to the polymer brush architecture of the precursor, in which the dense packing of growing polymer chains force adoption of a highly chain extended conformation with polymer chains oriented perpendicular to the substrate and thereby the eventual pore interface. As a consequence orientation of the physically constrained tethered carbon precursor in the brush polymer, pyrolysis of the precursor polymer results in formation of a carbon phase wherein the formed nanographene sheet exhibits edge exposure to the pore.

The key feature of all synthetic routes reported here is that a high fraction of the precursor polymer chains are oriented perpendicularly to the interface with the sacrificial phase. This interface becomes the pore wall after removal of the sacrificial phase. As Scheme III illustrates, orientation of polymer chains prior to graphitization allows the resultant nanographene sheets to be oriented perpendicular to the pore wall.

The consequence of high graphene edge exposure to the pores is that the specific capacitance per unit area should be far greater than values reported from activated carbon. Our results reported here, suggest that the edges of the nanographene structures are indeed available for added capacitance.

In another embodiment of the invention the sacrificial phase is an inorganic solid such as a silica particle or surface.

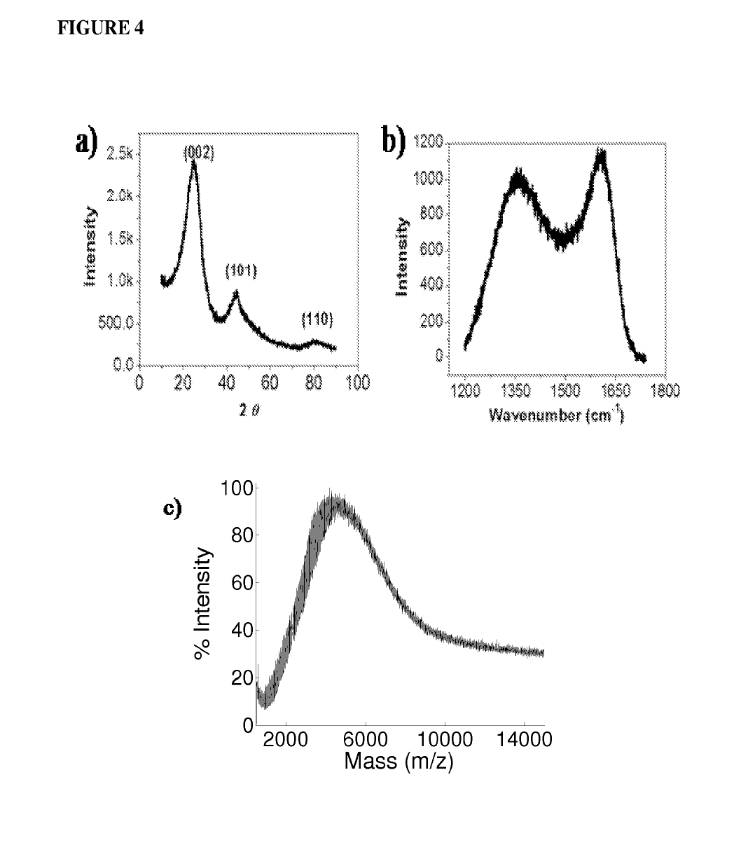

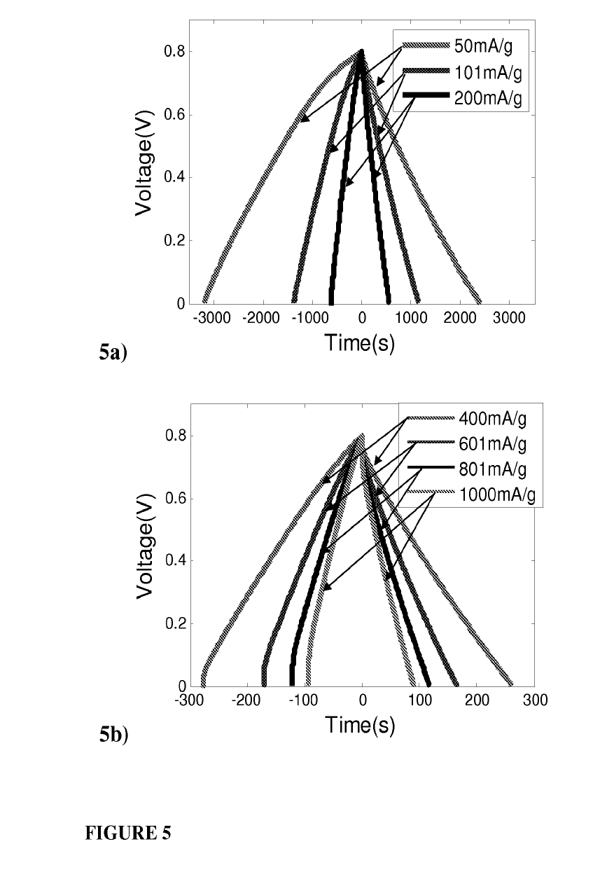

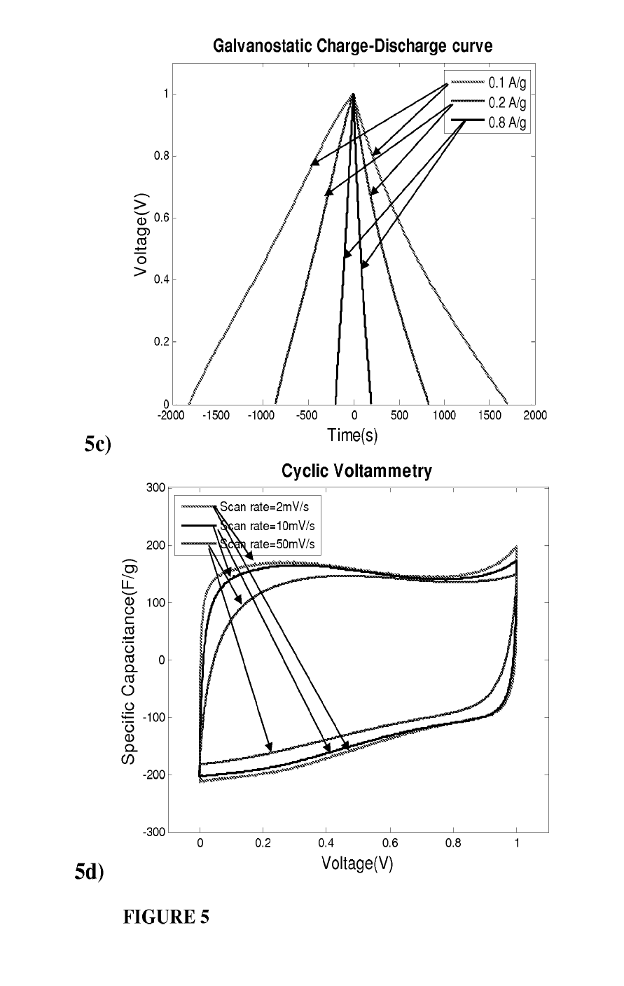

Each domain primarily comprises ˜2-8 nm, or even ˜3-5 nm nanographene structures as confirmed by WAXS, Raman and LDI-TOF, FIG. 4. The procedure results in formation of nanographene structures of sizes approximately 2-8 nm or in certain embodiments 3-5 nm in both directions dispersed in amorphous carbon matrix. The resulting porous nanographene structures may have a surface area ranging from about 4 nm² to about 64 nm², or in certain embodiments from about 6 nm² to about 25 nm² or even from about 9 nm² to about 25 nm². The creation of molecular architecture of this nature indeed improves the specific capacitance per unit area beyond currently available materials employing procedures in open art. Electrodes formed using the methodology described herein may have a specific capacitance ranging from about 100 F/g to about 250 F/g and a BET surface area ranging from about 300 m²/g to about 800 m²/g. In other embodiments, the electrodes may have a specific capacitance ranging from about 140 F/g to about 200 F/g and a BET surface area ranging from about 300 m²/g to about 800 m²/g. In other embodiments, the BET surface area may be as large as 1300 m²/g. For example, charge-discharge curves for a nanocarbon material from PAN-b-PBA precursors, FIG. 5 and Table 2, show specific capacitance values greater than 160 F/g, i.e. comparable to activated carbons, while the BET surface area (˜500 m²/g) of the as formed nanostructured carbons is far lower than that of typical activated carbon (greater than 1000 m²/g).

TABLE 2
Total specific capacity for each current density

Current Density (A/g)

| | 0.1 | 0.2 | 0.4 | 0.6 | 0.8 | 1.0 |
|---|---|---|---|---|---|---|
| Spec. | 170 | 166 | 161 | 158 | 155 | 153 |
| Cap. | | | | | | |
| (F/g) | | | | | | |

This may be due to the capability of these new materials to provide high values of charge storage in smaller areas enabled by the presence of edge-on nanographene structures. The specific capacitance per unit area for this particular nanocarbon material was found to be 34 μF/cm², a value that is already at least a 35% improvement over any reported to date. Therefore in one embodiment of the invention the specific capacitance per unit area for the formed nanocarbon material is greater than 30 μF/cm², or ranging from about 30 μF/cm² to about 100 μF/cm², or even from about 30 μF/cm² to about 70 μF/cm². Electrodes according to the various embodiments herein, such as electrodes for a supercapacitor, may display high retention of specific capacity. For example, according to one embodiment, supercapacitors comprising electrodes described herein may display a specific capacity retention rate of greater than about 60% at a current density of about 10 A/g. In other embodiments, supercapacitors comprising electrodes described herein may retain greater than or equal to 90% of an initial capacitance value, even after 4000 charge-discharge cycles, or more (for example at a current density of about 1 A/g).

Additionally, in the case of PAN as a carbon precursor, certain embodiments of the nanographene structures may comprise nitrogen atoms can reside along the zigzag edges of the graphene structure. Nitrogen, as mentioned earlier, may provide and an additional pseudocapacitance effect. The major differences in porous nanocarbon supercapacitors made from PAN block copolymers from commercially produced activated carbons are the level of graphitic material and the exposure of the graphitic nanographene sheets to the pore walls. Activated carbon commonly used for supercapacitors are primarily composed of amorphous carbon and typically display specific capacitance values around 200 F/g with surface areas ranging from 1000-3500 m²/g. In contrast, using PAN as a carbon precursor ensures a high level of graphitic content. As a result, one embodiments of the supercapacitor device having an electrode as described herein reached a specific capacitance value of 176 F/g while only having a BET surface area of 517 m²/g using 1 M H₂SO₄ as an electrolyte. In summary, we have seen similar values of specific capacitance but at widely different surface areas.

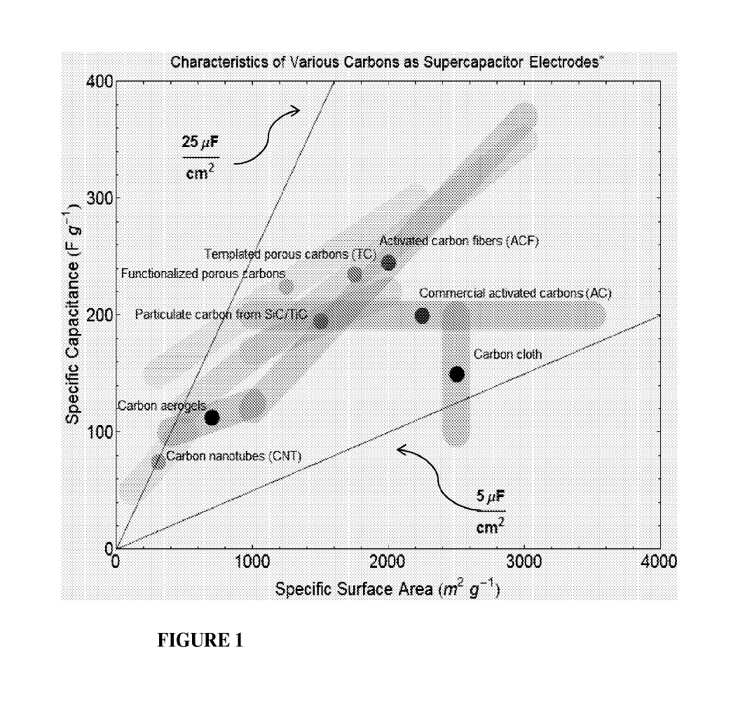

One largely unexplored area is related to specific capacitance per unit area. As shown in FIG. 1, typical values of EDL specific capacitance per unit area of carbon materials are in the range of 5-25 μF/cm². The typical value for amorphous carbon is in the middle of this range whereas capacitance on the edge plane of graphite can be far superior (50-70 μF/cm²) to all other known carbon storage mechanisms. [J Electrochem Soc 1971, 118, 711-714.] In contrast, the graphite basal plane is calculated to have a specific capacitance per unit area of 3 μF/g. The system explored in this disclosure consistently achieved values of ˜30-35 μF/cm². Without intending to be limited by any theory, one possible explanation may be the potential for high storage capacity in micropores. But this does not fit with the physical structure of our material, as it does not have a high number of micropores. These results can alternatively be explained by the recognition of the major role that graphene edges can play in establishing the unique electronic properties of nanographenes, in particular, due to the high concentration of electron density along zigzag edges and very high polarizability of edge states. An equally important aspect of achieving a high specific capacitance per unit area is the exposure of the nanographene edges. If the edges were imbedded or oriented away from the pores, the effects of their unique electronic properties would not be observed. Without intending to be limited by any theory, it is postulated that the edges of the nanographene sheets are indeed exposed to the pore walls as a result of their proper orientation that is ensured through our synthetic route.

In one embodiment, a key feature of using the block copolymer precursor synthetic routes reported herein is that a high fraction of the precursor polymer chains are oriented perpendicularly to the interface of the phase separated block copolymer. This is also true for our other synthetic approaches: polymer grafting from solid surface, polymer grafting from a porous template, and grafting from silica nanoparticles. All four of these approaches result in a similar material as a consequence of the prior orientation of the chains of the carbon precursor blocks.

In block copolymer precursors, this is a consequence of the effect of polymer chain stretching at the interface between immiscible phases. This interface becomes the pore wall after removal of the sacrificial phase. As Scheme III shows, the orientation of polymer chains prior to graphitization allows the resultant nanographene structures or nanographene sheets to be oriented perpendicular to the pore wall. Each of the four synthetic methods mentioned above contain the necessary conditions to create this orientation.

Therefore, in another embodiment of the invention the porosity of the final carbon structure can be modified by using (co)polymers of different mole fractions of the carbon precursor and the sacrificial phase, and/or different molecular weights of the carbon precursor phase, and the sacrificial phase or by the use of materials with other physically defined sacrificial phases such as flat surfaces, silica particles or porous silica substrates.

In one non-limiting example, the preparation of one nitrogen-free polymer precursor, poly(vinyl acetylene) (PVA) block copolymers and polyvinylacetylene based hybrid materials is a substitute to polyacrylonitrile in phase separable ordered materials. [Macromolecules 2008, 41, 9522-9524.] Precursors based on polyvinylacetylene provide a route to nitrogen free nanographene structures with different ion complexation behavior. Because of the reactivity of the terminal acetylene side groups, the polymerization can be carried out using a trimethylsilyl (TMS) protecting group, as seen in Scheme IV. According to these embodiments, the nanographene structures may be nanographene sheets having a substantially lamellar morphology, wherein the nanographene structures predominantly comprise carbon atoms along the zigzag edges of the nanographene structure. Structures of these types may be useful in electrodes, such as for a lithium ion battery. Other structures may be possible using a 4-vinyl pyridine monomer or a styrene monomer as a building block of the carbon precursor phase. In one embodiment, mixtures of different suitable monomer units may be used to form the carbon precursor phase.

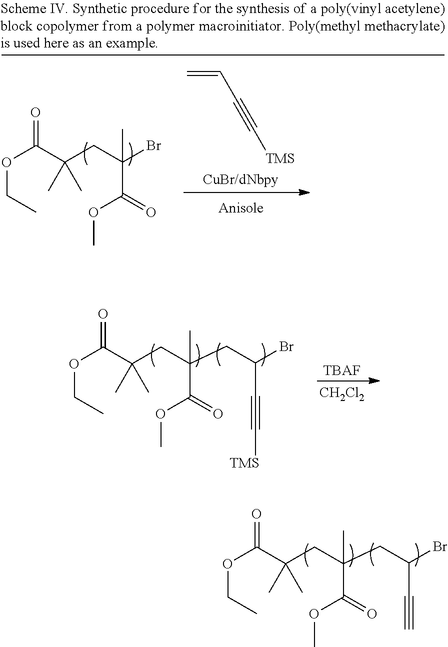

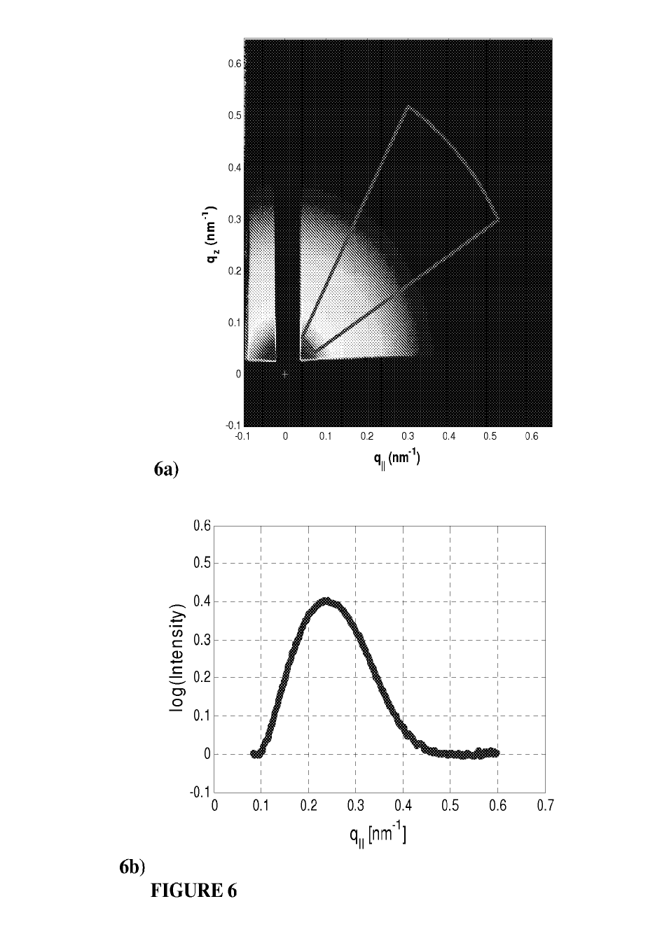

Vital to the utility of this system is the nanoscale phase separation of the block copolymer precursor and retaining that morphology in the resulting carbon. The nanoscale phase separation and morphology was studied using Atomic Force Microscopy (AFM) and Grazing Incidence Small Angle X-Ray Scattering (GISAXS) for several different block copolymers containing PVA and another polymer. A representative SAXS pattern of a sample of the ground macroscopically structured carbon formed by the stabilization pyrolysis procedure in the incorporated references is shown in FIG. 6. For all of the TMS protected samples, there was nanoscale phase separation. The second blocks synthesized and characterized were poly(methyl methacrylate) (PMMA), poly(n-butyl acrylate) (PBA), and poly(t-butyl acrylate) (PtBA), each at several different molecular weights. For some of the samples, the deprotected step (second step in Scheme IV) was performed and the morphology could be compared to the protected precursor. GISAXS revealed that the morphologies, most likely lamellae, were either oriented parallel or perpendicular to the substrate.

TABLE 3
Summary of the properties of PVA based block copolymers.

| | Block copolymer | Domain Spacing | | | |
|---|---|---|---|---|---|
| First Block | M_{n, exp.} | GISAXS | | AFM | |
| PMMA | 23000 | 21.5 (V) | | 11.5 | |
| Mn = 15400 | 19000 | 21.7 | | 32.3 | |
| PDI = 1.24 | | | | | |
| PMMA | 24000 | Not finished | | 19.6 | |
| Mn = 6370 | | — | — | 21.8 (P) | 21.4 (C) |
| PDI = 1.32 | | | | | |
| PMMA | 21800 | 13.3 | | 41.1 (weak) | |
| Mn = 14500 | | | | | |
| 1.24 | | | | | |
| PtBA | 1) 25000 | 1) 18.5 | 2) 19.9 | 1) 18.3 | 2) 18.9 |
| Mn = 10,000 | 2) 22000 | | | | |
| PDI = 1.10 | | | | | |
| PtBA | 34000 | 19.9 | | 26.1 | |
| Mn = 10,000 | | — | — | 11.2 | 29.7 |
| PDI = 1.10 | | | | (weak) | |
| PBA | 43400 | 23.5 | | 22.4 | |
| Mn = 10,000 | | — | — | NA | 22.7 |
| PDI = 1.13 | | | | | |

| | | | |
|---|---|---|---|
| PBA | 28000 | 14.7 | 40 |
| Mn = 6250 | | | |
| PDI = 1.09 | | | |

(“V”—spacing oriented parallel to substrate (vertical), “D”—TMS deprotected sample, “P”— polymer, “C”—carbon after pyrolysis).

A summary of the polymers synthesized and characterized are shown in Table 3. The sample names ending with “-D” indicate the deprotected samples. As seen in Table 3, none of the deprotected PVA block copolymer samples showed any phase separation, which could be viewed as limiting the usefulness of this particular PAN alternative. However, there are alternative routes to bypass this initial limitation. First is the possibility of TMS deprotection via heat treatment, where the TMS group would be thermally cleaved, and would immediately be pyrolyzed to avoid the time required for the blocks to become miscible. Second is the synthesis of PVATMS from silica templates followed by the etching of the silica with HF. This can applied to the PVATMS system, as the HF will also cleave the TMS protecting groups. A third approach is selection of a sacrificial phase that provides stable phase separation from the deprotected PVATMS. This phase separation may be based on philicity of the sacrificial phase, Tg of the sacrificial phase or crystalizability of the sacrificial phase.

Another carbon precursor polymer is a crosslinked polystyrene [Steckle, W. P., Jr. ACS Symp. Ser. 1997, 669, 26-36.] or poly(4-vinylpyridine). The carbon precursor phase can comprise a copolymer of two or more monomers each of which contribute to the formation of the nanostructured carbon. Other materials that may show an increased likelihood of exhibiting π-π stacking between units should also provide ordered nanographitic domains in the formed carbon structures.

However as discussed in detail below, in certain embodiments, the exemplary carbon precursor used in the lithium-ion battery and supercapacitor experiments was polyacrylonitrile (PAN), which is known to have residual nitrogen after pyrolysis that lies on the zigzag edges of the nanographenes. These nitrogen atoms may impart additional properties in the devices, possibly either beneficial or detrimental for specific targeted applications. For example, the electronegative nitrogen atoms may facilitate additional capacitance in supercapacitors in the form of pseudocapacitance.

This disclosure provides several facile routes to porous nanographene structures templated by the self assembly of well-defined block copolymers and hybrid materials containing constrained domains of polyacrylonitrile or other carbon precursors. Without intending to be limited by any particular mechanism, two potential mechanisms of control of the electronic structure of the formed porous nanographenes may be proposed:
bandgap control through control over the cluster size provided by pyrolysis temperature, temperature profile and precursor morphology; and
Fermi level and band edge control through the modification of the edge states accomplished by chemical modification of nanographene edges which is facilitated by the high porosity of the carbon structures formed by pyrolysis of multi-phasic materials prepared by controlled synthesis and controlled pyrolysis.

Laser Desorption Ionization mass spectroscopy provides first direct evidence that molecular weight distribution of nanographene sheets can be controlled by molecular weight of PAN block and block copolymer nanostructure.

Therefore one embodiment of the invention comprises processes for preparation of porous carbon structures based on multi-phase macromolecular precursors where the molecular orientation of the carbon precursor assure the edge-on orientation of the formed nanographitic domains with respect to pore walls, thus facilitating formation of electrodes with high specific capacitance per unit area.

Other embodiments of the present disclosure provide for a method for forming an electrode. According to these embodiments, the method may comprise the steps of forming a phase separated (co)polymer having a carbon precursor phase and a sacrificial phase; chemically or thermally removing the sacrificial phase and pyrolizing the (co)polymer to convert the carbon precursor phase into a porous carbon material comprising a graphitic carbon material having a nanoporous structure containing nanographene structures with edge-on topology to a plurality of formed pores; grinding the porous carbon material into a graphitic powder having a particle size ranging from about 1 nm to about 100 nm; and forming an electrode from the graphitic powder. Examples of the porous carbon material are set forth elsewhere herein.

In certain embodiments, the method may further comprise controlled stabilizing of the carbon precursor phase prior to pyrolysis. According to these embodiments, the controlled stabilizing of the carbon precursor phase may result in formation of the nanographene structures/sheets with edge on topology to the formed pores.

According to these methods, the phase separated (co)polymer may be synthesized from a (co)polymer, such as a block copolymer, from grafting a polymer from a surface, from grafting a polymer from a porous template, or from grafting a polymer from a silica surface, such as a silica particle or nanoparticles. In specific embodiments, the carbon precursor phase may comprise a polymer block formed from acrylonitrile monomer units, vinyl acetylene monomer units, 4-vinyl pyridine monomer units, styrene monomer units, or combinations of any thereof.

In specific embodiments, the sacrificial phase may be chemically removed. For example, where the sacrificial phase may comprise a silica material, the sacrificial phase may be chemically removed by an etching process that chemically reacts with the silica. In other embodiments, the sacrificial phase may be thermally removed. For example, when the sacrificial phase is a polymeric phase, such as an alkyl (meth)acrylate phase or other thermally degradable phase material, the sacrificial phase may be thermally removed during the pyrolysis process that also converts the carbon precursor phase into the carbon material described herein. In one specific embodiment, the carbon precursor phase may comprise polyacrylonitrile and the sacrificial phase may comprise a poly(alkyl (meth)acrylate), such as poly(butyl acrylate) (PBA), wherein the material phase separates at the nanoscale with a morphology determined, for example, by one or more of the block copolymer composition and the weight ratio of the blocks.

The utility of the electrode materials produced by the methods described herein may be demonstrated by their use as an electrode for a supercapacitor or a lithium ion battery, as described in detail herein. According to certain embodiments, the electrodes produced by these methods may have a specific capacitance pre unit area of greater than about 30 μF/cm².

The present invention as set forth in the specification and defined by the claims will be better understood when read in conjunction with the following non-limiting exemplary examples.

### EXAMPLES

### Example 1

Formation of well defined carbon nanostructures from a PAN-b-PBA block copolymer (structural formula (PAN)₁₀₆(PBA)₂₀₂) with a polydispersity of 1.3 and a composition of 17.8 wt. % PAN provides details of a typical stabilization and pyrolysis procedure. This example demonstrates that the PAN phase is directly converted to carbon structures while retaining the morphology of the first formed phase separated block copolymer.

A solution of PAN-b-PBA in N,N-dimethyl formamide was deposited on an electronic-grade quartz substrate at 90° C. using a ‘zone casting’ method. [T. Kowalewski, R. D. McCullough, and K. Matyjaszewski, Eur. Phys. J. E 10, 5 (2003)] Small amounts of contamination, especially oil, prevented the carbon films from adhering well to the substrate. Hence to ensure uniform film deposition and adhesion, the substrates were thoroughly cleaned with acetone and iso-propanol prior to film deposition. The films were stabilized in air at 280° C. for two hours and then heated in a N₂ atmosphere as the temperature was increased at a rate of 20° C./min to the designated pyrolysis temperature. The films were held at the pyrolysis temperature for 30 minutes and then cooled by convection to room temperature. The pyrolyzed films showed good adhesion to the substrate; it was not possible to lift the films from the surface by using a sharp cutting edge. The films could be separated only by dissolution of the substrate in hydrofluoric acid.

The surface topography of films was investigated using atomic force microscopy (AFM) in tapping mode. The studies were conducted using a NanoScope III-M system (Digital Instruments, Santa Barbara, Calif.), equipped with a J-type vertical engage scanner.

The poly(n-butyl acrylate) (PBA) block in a PBA-b-PAN copolymer precursor serves as a sacrificial phase, which after pyrolysis the volume fraction of the sacrificial phase leaves behind pores. Therefore, the relative proportion of each polymer block affects the total pore surface area and the pore structure, which may lead to changes in an electrochemical capacitance.

### Example 2

### Block Extension of Poly(n-butyl acrylate) with Polyacrylonitrile (PAN), Pyrolysis of Formed Block, and Formation of an Electrode

A solution of a PBA macroinitiator (6,000 g/mol, 1 g), acrylonitrile (2.6 mL), and DMSO (4.6 mL) was subjected to 3 freeze-pump-thaw cycles then backfilled with N₂ before addition of 2-2′-bipyridine (bpy) (31.9 mg) and CuCl (10.2 mg). The reaction proceeded for 8 hours, and the polymer was purified by precipitation into a 50:50 water:methanol mixture. The block copolymer powder was stabilized at 280 ° C. under air for two hours and then pyrolyzed through heating to 700° C. under nitrogen for 30 minutes, with parallel volatilization of the PBA block. The formed carbon powder was ground using a mortar and pestle. The ground powder was suspended in NMP with 5 wt % acetylene black and 10 wt % poly(vinylidine fluoride). The final solid concentration was 40 mg/mL. The suspension was drop cast onto a stainless steel mesh on a hot plate at 70° C. for 2 hours and then dried in a vacuum oven at 100° C. for 2 hours.

### Electrochemical Measurement Setup.

Two electrode cells were built using Teflon Swagelok with a porous polypropylene separator between them and 1 M H₂SO₄ was used as an electrolyte. A Galvanostatic charge-discharge curve (current load from 100 to 1000 mA g⁻¹), cyclic voltammetry (scan rate of potential from 1 to 100 mV s⁻¹), and an electrochemical impedance spectroscopy (frequency range from 100 kHz to 1 mHz with 5 mV voltage amplitude) were obtained using a potentiostat/galvanostat (Biologic, model VMP USA).

### Example 3

Three block copolymers with different proportions of the carbon precursor phase were prepared. The molecular composition of the different copolymers is summarized in Table 4.

TABLE 4

| DP of BA | DP of AN | Wt % of PAN | M.W. | Mw/Mn |
|---|---|---|---|---|
| 89 | 84 | 28.1 | 16,000 | 1.20 |
| 90 | 159 | 42.2 | 20.000 | 1.25 |
| 90 | 215 | 49.7 | 23,000 | 1.27 |

The three PAN-b-PBA block copolymers were pyrolyzed to nanoporous carbon materials and converted to powder. The resultant BET specific surface areas were determined to be 368, 649, and 569 m² g⁻¹, respectively. The pore size distributions revealed that carbon from block copolymers with 42.2 wt % of PAN had the largest mesopores, which was manifested by a large BET surface area in comparison with other carbon materials. Well-developed mesoporous structure with domain spacing of 28.8 nm (q=0.218 nm⁻¹) was also observed in small angle x-ray scattering (SAXS) patterns. The observed spacing was comparable to the mesopore size from the pore size distribution.

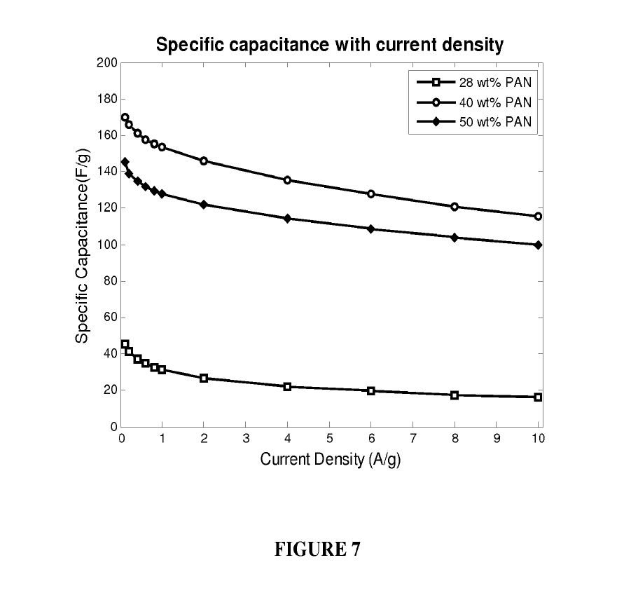

FIG. 7 shows the specific capacitance (from the Galvanostatic discharge curve) with different current densities; 1V of discharging voltage window and 1M sulfuric acid as an electrolyte. Table 5 shows the maximum specific capacitance and rate capability; retention rate is obtained by dividing a current density at 10 A/g with the one at 0.1 A/g, so, a higher retention rate means a better rate capability.

TABLE 5
Summary of capacitance measurements for nanocarbon samples.

| Wt % of PAN | Max. Spec. Cap.(F/g) | Retention (%) |
|---|---|---|
| 28 | 45.4 | 35.1 |
| 42 | 170 | 68.0 |
| 50 | 145 | 68.5 |

Among the three formed carbon structures, the carbon from 42 wt % of PAN block copolymer showed a highest maximum capacitance (170 F/g) and 68% of this value still remained at 10 A/g of current density (Table 5).

The capacitance value of supercapacitor with the nanoporous carbon electrodes described herein is comparable to the one of commercial activated carbons (100-250 F/g). However, the rate capability, which is directly related to the power density, is superior to the values reported for activated carbons. Without intending to be limited by any theory, the reason such a good rate capability of nanoporous carbon might be due to the interconnected pore structure between mesopores and micropores. Additionally, since the carbonization procedure for preparing nanoporous carbon is very simple one can easily control the surface area and pore size distribution by changing the block copolymer composition of carbon precursor using a Controlled Radical Polymerization (CRP) procedure, preferentially Atom Transfer Radical Polymerization. This control makes the formed nanoporous carbon a very promising electrode material for supercapacitors.

The galvanostatic charge-discharge curve and cyclic voltammetry are presented in FIG. 5. The representative properties of ideal electrochemical double layer capacitor (a triangular shape of charge-discharge curve and a rectangular shape of cyclic voltammetry) were obtained.

One known advantage that supercapacitors have over batteries is the minimal amount of degradation observed in these devices. In order to check this durability performance for the disclosed nanocarbon system the supercapacitor, in which the nanoporous carbon electrodes were used, underwent 4000 cycles of charge-discharge. The nanocarbon supercapacitor only lost 10% of its initial capacitance value after 4000th cycle in case of 1M sulfuric acid, and 30% in 5M KOH electrolyte.

### Example 4

### Preparation of Mesoporous Linear PAN Material

The surface of a SiO₂ particles were modified with an ATRP initiator as disclosed in incorporated references and placed in the reactor. Since copper can react with the halogen at the end of polymer chain it is hard to get high M_{w} and low PDI PAN via normal ATRP therefore we used the ARGET ATRP procedure. In order to slow the rate of polymerization, a weak reducing agent, glucose, was employed to maintain a high fraction of the copper II deactivator in the contacting solution. The ratio of reagents were AN: SiO₂—Br: EBiB: CuCl₂: TPMA: Glucose=2000: 1: 0.025: 0.25: 0.25; and a reaction T=55° C. in the presence of DMSO: 200 v % of AN. The low molecule weight initiator, EBiB, was added to follow the growth of the tethered PAN chains. The free polymer had a MW of 48,000 by NMR while the theoretical MW was 71,400. The PDI was around 1.1.

A similar reaction was conducted using a silica wafer and the thickness of polymer layer on the surface was measured by ellipsometer at different sites: 30.9 nm, 32.9 nm, 31.8 nm. Average thickness is 31.9 nm. Grafting density is 0.40 chain/nm².

### Discussion of Examples

The nanocarbon material prepared from the pyrolysis of PAN-b-PBA was investigated for improved rate capability to that of common anodes for lithium ion batteries (e.g. graphite). It was hypothesized that the disclosed procedures for control of the nanoporous network throughout the carbon material would facilitate lithium ion transport, and thus further improves the rate. Several precursor materials and processing variations were used in order to arrive at the optimal system. Without out any drastic changes, it appears that the optimal conditions were achieved. Those samples were prepared by grinding a composition of formed nanocarbon material (85%), PVDF binder (5%) and acetylene black (10%) and suspending in a slurry of NMP (200 mg/mL). The slurry was poured over a steel mesh that was resting on aluminum foil which was being gently heated on a hot plate. The drying suspension remained on the hotplate for two hours and was then dried further in a room temperature vacuum oven overnight (16 hours). The anodes had relatively good mechanical strength and were much less brittle than the original samples. The addition of the steel mesh also greatly improved the overall resistance of the device due to mechanical contact. This was evident in the evolution of the iR drop at the beginning of the capacitance measurements.

Both lithium ion battery and supercapacitor devices were successfully prepared utilizing a porous nanographene containing carbon material prepared by controlled pyrolysis of PAN-b-PBA copolymers, as described herein. The test for lithium ion batteries indicated that the overall storage capacity is competitive with commercial products. In contrast to the battery tests, the results found from the supercapacitor tests demonstrated that the specific capacitance is comparable to conventional supercapacitors from activated carbons, while the rate capabilities are improved. The fundamental difference between these two systems is the charge storage mechanism. In lithium-ion batteries, the lithium ions usually intercalate between the graphite sheets and create a stable LiC₆ coordination. Several other potential storage mechanisms that highlight the large amount of graphitic edges capable of balancing the lithium ions that should be accessible in a semi-graphitic nanoporous system similar to the one discussed in this disclosure prepared from non-nitrogen containing carbon precursors will be examined in the expectation that performance can be significantly improved. In supercapacitors, the charge storage is primarily faradaic and no covalent bonds are formed. The rest of the charge storage is most likely in the form of pseudocapacitance from the residual nitrogen atoms that reside on the edges of the nanographene sheets as a result of the pyrolysis mechanism of PAN. The large performance disparity can be explained from their differences in charge storage mechanisms when applied to amorphous carbon. In lithium ion storage, these ions irreversibly bond with the amorphous carbon. This was the primary reason for the large capacity drop between the first and second discharge. In supercapacitors, because the charge storage mechanism is faradaic, the amorphous carbon does not play a detrimental role in the device.

In the supercapacitor work, it was determined that the unique electronic nature of the zigzag edges in nanographene combined with our synthetic scheme that ensures their edge exposure to the pore wall resulted an interesting supercapacitor material, whose specific capacitance per unit area is higher than most known commonly used carbon materials. These results illustrate the potential for these materials to be used in energy storage solutions.

Recent work has shown that CO₂ activation of the carbon material increases the surface area up to three times but the specific capacitance drops as much as 20%. This directly points to the role the nanographene edges play in faradaic charge storage mechanisms. While activation was detrimental to the supercapacitor performance by passivation of the edges using CO₂ activation, it is envisioned that this may be beneficial for lithium ion storage as the energetic barrier for intercalation at the nanographene edges could be lowered. Therefore in one embodiment of the disclosure, CO₂ activation may be utilized when the formed nanostructured carbon is used in lithium ion storage units.

The continued development of nitrogen-free polymers as a carbon precursor that exhibits the necessary nanoscale morphology required for batteries and supercapacitors will provide a different spectrum of properties in the targeted applications.

1. An electrode comprising:
a porous carbon material comprising a graphitic carbon material having a nanoporous structure containing nanographene structures with edge-on topology to a plurality of &wiled pores, dispersed in an amorphous carbon matrix,
wherein the electrode has a specific capacitance per unit area of greater than about 30 μF/cm².

2. The electrode of claim 1, wherein the graphitic carbon material is a powder having a particle size ranging from about 1 μm to about 100 μm and a BET surface area greater than or equal to about 300 m²/g.

3. The electrode of claim 1, wherein the porous nanographene structures have a surface area of from about 4 nm² to about 64 nm².

4. The electrode of claim 1 any of claims 1, wherein the nanographene structures are nanographene sheets having a substantially lamellar morphology.

5. The electrode of claim 1, wherein the nanographene structures further comprise nitrogen atoms along the zigzag edges of the nanographene structure.

6. The electrode of claim 1, wherein the electrode has a specific capacitance per unit area of from about 30 μF/cm² to about 70 μF/cm².

7. The electrode of claim 1 any of claim 1, wherein the electrode is an electrode in a supercapacitor.

8. The electrode of claim 7, wherein the supercapacitor has a specific capacitance ranging from about 100 F/g to about 250 F/g and a BET surface area ranging from about 300 m²/g to about 800 m²/g.

9. The electrode of claim 7, wherein the supercapacitor has a retention rate of greater than about 60% at a current density of about 10 A/g.

10. The electrode claim 7, wherein the supercapacitor retains greater than or equal to 90% of an initial capacitance value after 4000 charge-discharge cycles.

11. The electrode of claim 1, wherein the electrode is an anode for a lithium ion battery.

12. The electrode of claim 11, wherein the nanographene structures are nanographene sheets having a substantially lamellar morphology and wherein the nanographene sheets predominately comprise carbon atoms along zigzag edges of the nanographene sheets.

13. The electrode of claim 11, further comprising lithium ions, wherein the lithium ions are located at a site selected from the group consisting of intercalated between the nanographene structures, located in a cavity between the nanographene structures, located at zigzag and armchair edges of the nanographene structures, or combinations of any of these locations.

14. The electrode of claim 11, further comprising CO₂ activation of the electrode when the electrode is used in lithium ion storage units.

15. A method for forming an electrode comprising:
forming a phase separated (co)polymer having a carbon precursor phase and a sacrificial phase;
chemically or thermally removing the sacrificial phase and pyrolizing the (co)polymer to convert the carbon precursor phase into a porous carbon material comprising a graphitic carbon material having a nanoporous structure comprising nanographene structures with edge-on topology to a plurality of formed pores;
grinding the porous carbon material into a graphitic powder having a particle size ranging from about 1 nm to about 100 nm; and
forming an electrode from the graphitic powder.

16. The method of claim 15, wherein forming the phase separated (co)polymer having a carbon precursor phase and a sacrificial phase comprises a step selected from synthesizing a block copolymer, polymer grafting from a surface, polymer grafting from a porous template, or polymer grafting from silica nanoparticles.

17. The method of claim 15, wherein the carbon precursor phase comprises a polymer block formed from acrylonitrile monomer units, vinyl acetylene monomer units, 4-vinyl pyridine monomer units, styrene monomer units, or combinations thereof.

18. The method of claim 15, wherein pyrolizing the (co)polymer also thermally removes the sacrificial phase.

19. The method of claim 15, wherein the carbon graphitic material takes on a morphology of the phase separated carbon precursor phase, said morphology selected from the group consisting of cylindrical morphology, gyroidal morphology, lamellar morphology, branched morphology, a continuous carbon precursor phase morphology and combinations thereof.

20. The method of claim 19, wherein the carbon graphitic material has a lamellar morphology.

21. The method of claim 15, wherein the carbon precursor phase comprises polyacrylonitrile block and the sacrificial phase comprises a poly(alkyl (meth)acrylate) block which phase separate at the nanoscale with a morphology determined by the (co)polymer composition and weight ratio of the blocks.

22. The method of claim 15, further comprising controlled stabilizing of the carbon precursor phase prior to pyrolysis, wherein the controlled stabilizing of the carbon precursor phase results in formation of nanographene sheets with edge-on topology to the formed pores.

23. The method of claim 15, wherein greater than 50% of carbon precursor polymer segments are oriented perpendicularly to an interface, wherein the interface is an interface of a phase separated segmented copolymer or an interface of a hybrid material.

24. The method of claim 15, wherein the electrode is an electrode for a supercapacitor or a lithium ion battery.

25. The method of claim 15, wherein the porous nanographene structures have a surface area of from about 4 nm² to about 64 nm².

26. The method of claim 15, wherein the specific capacitance per unit area of the graphitic powder is greater than about 30 μF/cm².

27. The method of claim 15, wherein the phase separatedcopolymer is a block copolymer formed by a controlled radical polymerization process.
